(19) United States
(12) Patent Application Publication
(10) Pub. No.: US 2025/0164711 A1
(43) Pub. Date: May 22, 2025

(54) OPTICAL MODULE

(71) Applicant: INNOLIGHT TECHNOLOGY (SUZHOU) LTD., Jiangsu (CN)

(72) Inventors: Wenbo ZHANG, Jiangsu (CN); Shamei SHI, Jiangsu (CN); Peng CHEN, Jiangsu (CN); Anli LI, Jiangsu (CN); Changwu LU, Jiangsu (CN)

(73) Assignee: INNOLIGHT TECHNOLOGY (SUZHOU) LTD., Jiangsu (CN)

(21) Appl. No.: 18/729,508

(22) PCT Filed: Nov. 1, 2022
(86) PCT No.: PCT/CN2022/128842

§ 371 Date: Jul. 17, 2024

(30) Foreign Application Priority Data
Jan. 27, 2022 (CN) 202220231480.2

(51) Int. Cl. G02B 6/42; G02B 6/38

(52) U.S. Cl. CPC G02B 6/423; G02B 6/3879; G02B 6/421; G02B 6/4244; G02B 6/4257; G02B 6/426

(57) ABSTRACT

An optical module, comprising a housing, and a circuit board and an optical assembly disposed in the housing, wherein the housing has an optical port, an adapter is disposed at the optical port, the optical assembly comprises an optical receptacle disposed in the adapter by limited in a radial direction, and wherein the optical module further comprises a pressing piece and a plugging structure disposed in the housing, wherein the plugging structure is oppositely disposed on both sides of an axis of the optical receptacle, two opposite ends of the pressing piece are plugged into the plugging structure; the pressing piece is provided with at least one elastic piece structure, the elastic piece structure has an elastic piece abutting against the optical receptacle along an axial direction of the optical receptacle, and the two ends of the pressing piece abut against the plugging structure.

### TECHNICAL FIELD

The disclosure relates to the field of optical communication technology, and in particular to an optical module.

### TECHNICAL BACKGROUND

With the rapid development of communication technologies and the growing demand for cloud computing, the demand for high-speed optical modules is increasing gradually. The normal operation of an optical module relies on stable light-emitting function; in the meantime, the optical assembly inside the optical module has high sensitivity to its position. If the optical assembly is slightly stressed, the position of the optical assembly is very likely to shift, and the light-emitting and receiving functions will be affected. The optical receptacle in the optical assembly needs to be mounted in an adapter, and an external connector is plugged into the adapter to achieve docking with the optical receptacle. However, the optical receptacle in the prior art is fixed through adhesive or laser welding. Repair is not easy in the case of laser welding, once repair is required for the optical receptacle, the optical receptacle is normally scrapped. The shortcoming of using adhesive for fixing the optical receptacle is poor reliability. After the optical receptacle is used for a period of time, the optical receptacles are prone to loosening, causing problems such as light loss, and the optical components and module housing are very likely to be contaminated during repair.

In order to solve the above problems, the Chinese patent application “An optical module” (application number: 202020294182.9) provides a solution that uses EMI protection members to limit and fix the optical connector (optical receptacle). An upwardly bent elastic piece end is formed at the bottom of an EMI protection member, and the elastic piece end is set to rest against the optical connector for positioning. The bottom of the EMI protection member rests against the mounting groove at the bottom of the lower cover with the top rests against the upper cover, and the EMI protection member is compressed and fixed through covering the upper and lower covers.

Although the solution in the above patent application solves the problem brought by fixing the optical connector (optical receptacle) through welding and adhesive, it still troublesome to fix the EMI protection member. Before the upper cover is covered on the lower cover, the main position where EMI protection member is subjected to force lies in the elastic piece and the bottom thereof. The upper end (third end) of the EMI protection member is in a free condition, so it is difficult to ensure that the optical connector is set in the right position. Before the upper cover is covered on the lower cover, it is necessary to push the EMI protection member to the right position and then the upper cover is closed on the lower cover. Even so, the method for fixing through pressing by covering the upper and lower covers has poor stability. When the optical receptacle is docked with the external connector, during the process that the force applied by the external connector to the optical receptacle is transmitted to the EMI protection member, the EMI protection member is prone to deflection or loosening, and ultimately causing deflection of the mounting position of the optical receptacle, thus leading to light loss and so on. Additionally, when the speed of the optical module becomes higher increasingly, and the optical connector requires the configuration of upper and lower layers or more layers superimposed onto each other, it is difficult for the EMI protection member to expand upward. Accordingly, it is challenging to meet the requirement of fixing upper and lower layers or more layers of the optical connectors.

### INVENTION SUMMARY

### Technical Problem

The purpose of the disclosure is to provide an optical module that is able to keep the optical receptacle at an accurate position and make repair the optical receptacle easy, and with high reliability.

### Plan for Solving Problem

### Plan for Solving Technical Problem

In order to achieve one of the above purposes of the disclosure, an embodiment of the disclosure provides an optical module including a housing, and a circuit board and an optical assembly provided in the housing. The housing has an optical port, an adapter is provided at the optical port. The optical assembly includes an optical receptacle disposed in the adapter by limited in a radial direction. The optical module further includes a pressing piece and a plugging structure provided in the housing, the plugging structure is oppositely disposed on both sides of an axis of the optical receptacle. Two opposite ends of the pressing piece are plugged into the plugging structure. The pressing piece is provided with at least one elastic piece structure, the elastic piece structure has an elastic piece abutting against the optical receptacle along the axial direction of the optical receptacle, and both ends of the pressing piece abut against the plugging structure, so that the elastic piece presses the optical receptacle into the adapter.

As a further improvement of an embodiment of the disclosure, the housing includes a first housing and a second housing that cover each other, and the first housing includes a bottom plate.

The plugging structure includes a first resisting wall located on both sides of the bottom plate respectively and extending in a direction perpendicular to the bottom plate. Both ends of the pressing piece respectively abut against the first resisting wall.

As a further improvement of an embodiment of the disclosure, the adapter has a second resisting wall that abuts against one side of the optical receptacle close to the optical port along the axial direction of the optical receptacle, and the elastic piece abuts against one side of the optical receptacle facing away from the optical port. The first resisting wall and the second resisting wall are disposed opposite to each other.

As a further improvement of an embodiment of the disclosure, the first housing further includes a side wall disposed on both sides of the bottom plate respectively, and the first resisting wall is disposed on the side wall.

Alternatively, the adapter is provided with opposite protrusions respectively at both ends of the second resisting wall, and the first resisting wall is disposed on the protrusions.

As a further improvement of an embodiment of the disclosure, the adapter further has a position-limiting hole extending along the axial direction of the optical receptacle. The optical receptacle includes a sleeve and a flange protruding along the radial direction of the optical receptacle. The sleeve on one side of the flange facing the adapter is adapted in the position-limiting hole. One end of the flange abuts against the second resisting wall, and the other end abuts against the elastic piece.

As a further improvement of an embodiment of the disclosure, the pressing piece is a sheet structure, and the sheet structure includes a plug-in board and the elastic piece structure. Both ends of the plug-in board are plugged into the plugging structure. The plug-in board is provided with a receding channel extending along the insertion direction thereof, and the receding channel is adapted to the sleeve of the optical receptacle located on one side of the flange facing away from the adapter.

The elastic piece structure includes at least two elastic pieces, and the at least two elastic pieces are respectively disposed on both sides of the receding channel.

As a further improvement of an embodiment of the disclosure, the elastic piece includes a resisting portion abutting against the flange, a connection portion connecting the resisting portion and the plug-in board, and the connection portion may be deformed relative to the plug-in board.

As a further improvement of an embodiment of the disclosure, one end of the resisting portion facing away from the connection portion is a free end.

As a further improvement of an embodiment of the disclosure, the free end is provided with a guide portion, and the guide portion is inclined in a direction facing away from the flange.

The connection portion, the resisting portion and the free end extend along the insertion direction.

As a further improvement of an embodiment of the disclosure, at least two receding channels are disposed on the plug-in board, and at least two elastic piece structures are disposed along the extending direction of each receding channel. The number of the elastic piece structure corresponds to the number of the optical receptacle one-to-one.

As a further improvement of an embodiment of the disclosure, the pressing piece further includes a handle plate connected to the end of the plug-in board, and the handle plate extends in a direction facing away from the second resisting wall.

The handle plate is disposed at one end of the plug-in board that is relatively far away from the bottom plate.

As a further improvement of an embodiment of the disclosure, the pressing piece further includes a position-limiting protrusion protruding from both ends of the plug-in board, and the position-limiting protrusion is symmetrically arranged relative to the handle plate; the plugging structure further includes a position-limiting portion that is adapted to the position-limiting protrusion to limit the position of the plug-in board.

As a further improvement of an embodiment of the disclosure, the pressing piece is made of an elastic conductive material.

### Beneficial Effects of Invention

### Beneficial Effects

Compared with the prior arts, in the embodiment of the disclosure, the optical receptacle is elastically held in the adapter through the elastic piece structure provided on the pressing piece. The two opposite ends of the pressing piece are plugged into the plugging structure on both sides of the first housing, so that the pressing piece is less likely to be prone to deflection and loosening when pressing against the optical receptacle, thereby ensuring the accuracy of the mounting position of the optical receptacle and avoiding the problem of light loss. In the meantime, the pressing piece is fixed by plugging, which is simple, convenient and has good stability, making it easy to expand multiple elastic pieces in a vertical manner to meet the requirement of fixing multi-layer optical receptacles.

### BRIEF DESCRIPTION OF DRAWINGS

### Description of Drawings

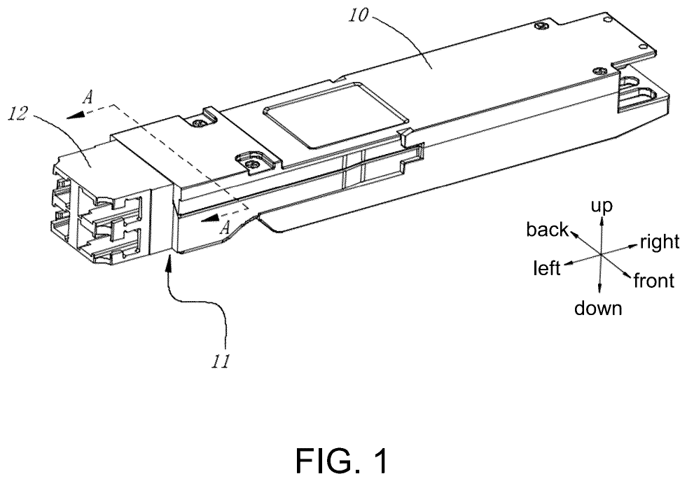

FIG. 1 is a three-dimensional schematic view of an optical module in an embodiment of the disclosure.

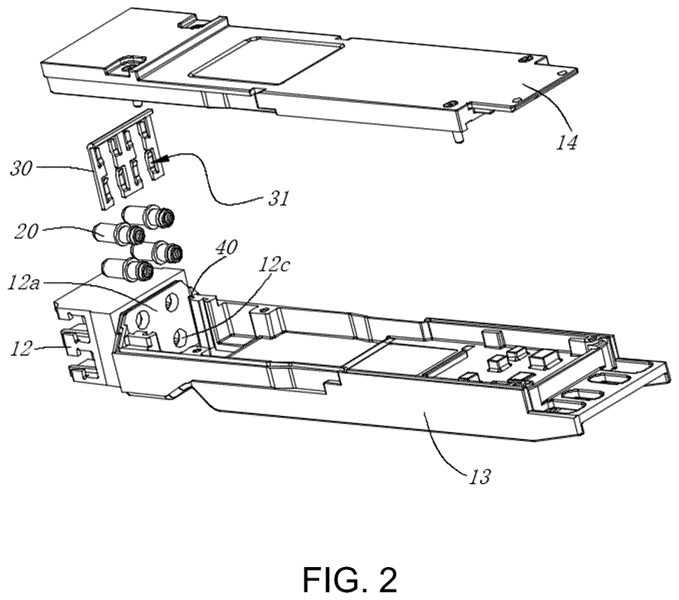

FIG. 2 is an exploded schematic view of the optical module in FIG. 1.

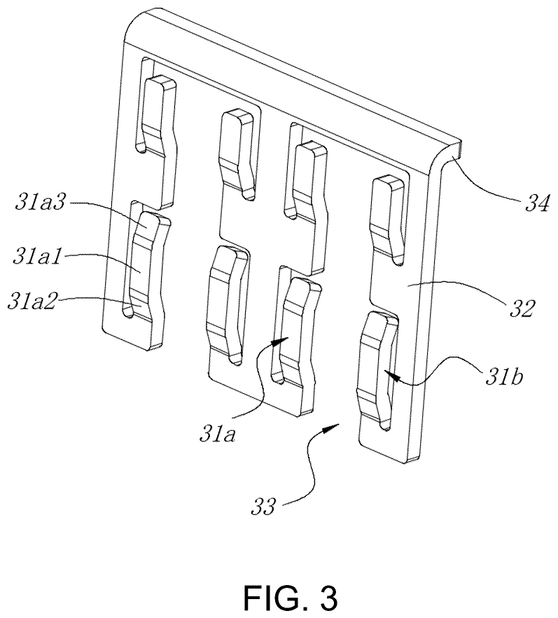

FIG. 3 is a three-dimensional schematic view of the pressing piece in FIG. 1.

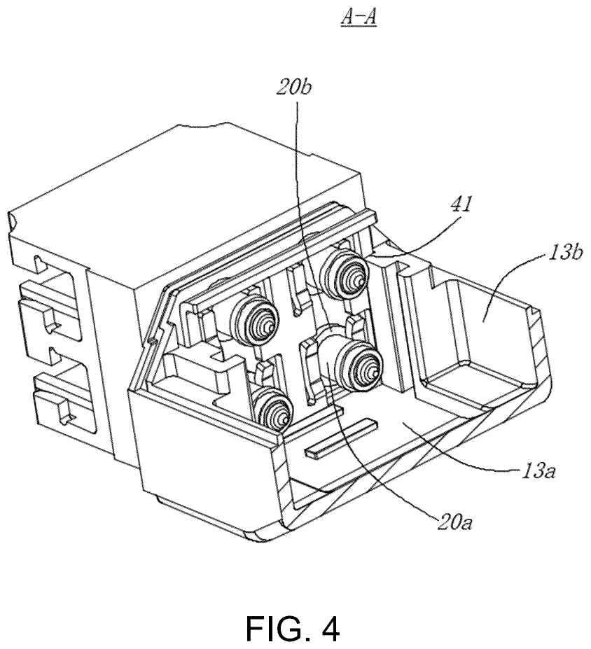

FIG. 4 is a three-dimensional cross-sectional view taken along line A-A in FIG. 1, with the second housing hidden.

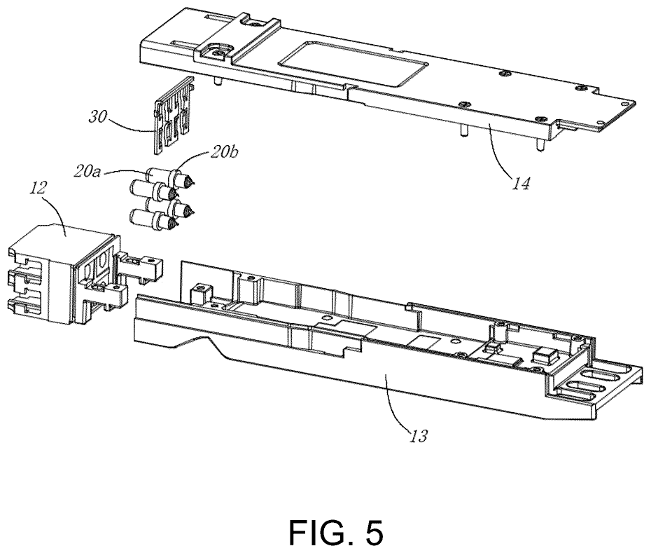

FIG. 5 is a three-dimensional exploded schematic view of the optical module in another embodiment of the disclosure.

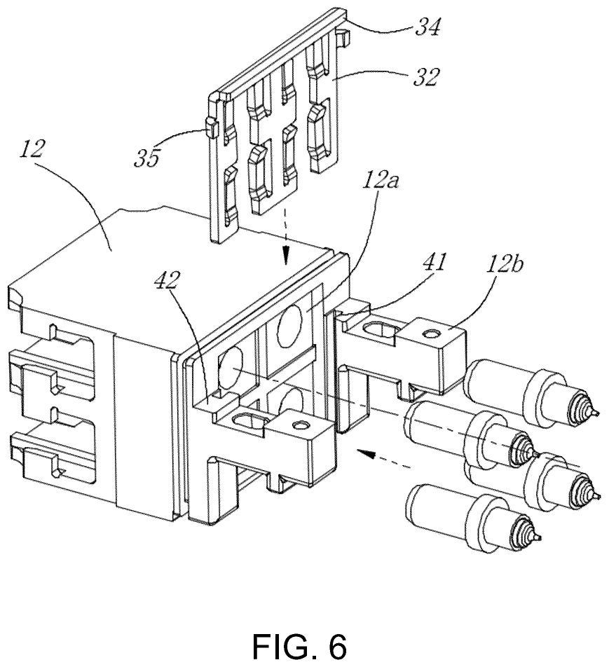

FIG. 6 is a partially exploded schematic view of the adapter in FIG. 5.

### EMBODIMENTS OF INVENTION

### Embodiments of the Disclosure

The present disclosure will be described in detail below with reference to the specific embodiments shown in the accompanying drawings. However, these embodiments do not limit the present disclosure. Structural, method, or functional changes made by those of ordinary skill in the art based on these embodiments are all included in the scope to be protected by the present disclosure.

It should be understood that terms used herein such as “upper,” “lower,” “outer,” “inner.” and the like for expressing relative positions in space are adopted for convenience of describing the relationship between one element/one feature and another element/feature as shown in the drawings. The spatially related terms may be intended to encompass different orientations of the device in use or operation in addition to the orientation illustrated in the drawings.

The optical module may be otherwise oriented (rotated by 90 degrees or at other orientations) and the spatially related terms used herein are interpreted accordingly. For example, in the disclosure, for the convenience of description, when the optical module is placed as shown in FIG. 1, six directions, including up and down, left and right, and front and back, are defined.

Referring to FIG. 1, an optical module provided by a preferred embodiment of the disclosure includes a housing 10, and a circuit board and an optical assembly disposed in the housing 10. The circuit board and part of the optical assembly are omitted in the drawing. The housing 10 has an optical port 11. In this embodiment, the housing 10 further has an electrical port. The optical port 11 and the electrical port are normally disposed at two ends of the housing 10. Therefore, the optical port 11 is only illustratively shown in FIG. 1 which is disposed at the left end of the housing 10.

Further, an adapter 12 is disposed at the optical port 11. In this embodiment, the adapter 12 is of LC type. Of course, the adapter 12 may also be SC type, FC type, MINI CS or other types. The adapter 12 is fixed in the optical port 11 and is configured to be docked with an external corresponding connector.

Referring to FIG. 2, further, the optical assembly includes an optical receptacle 20 disposed in the adapter 12 by limited in a radial direction. In this embodiment, after the optical receptacle 20 is disposed in the adapter 12, one end of the optical receptacle 20 extends into the adapter 12, and is limited in radial direction by the adapter 12 that will not causing radial offset. The end of the optical receptacle 20 extending into the adapter 12 is docked with an external connector, and the other end is optically coupled to the optoelectronic chip through an optical fiber, and the optoelectronic chip is electrically connected to the circuit board.

Further, the optical module further includes a pressing piece 30 and a plugging structure 40 disposed in the housing 10. In this embodiment, the pressing piece 30 is detachably connected to the plugging structure 40 in the housing 10, which not only facilitates the mounting of the optical receptacle 20, but also facilitates the subsequent repair and replacement of the optical receptacle 20. Moreover, the pressing piece 30 adopts a sheet structure, which saves space in the left and right directions of the optical module. Here, the left and right directions refer to the axial extending direction of the optical receptacle.

Specifically, the plugging structure 40 is oppositely disposed on both sides of the axis of the optical receptacle 20, and the two opposite ends of the pressing piece 30 are plugged into the plugging structure 40. In this embodiment, the plugging structure 40 is oppositely disposed on both sides of the axis of the optical receptacle 20, so that when the optical receptacle 20 receives an external force in the axial direction and acts on the pressing piece 30, the pressing piece 30 does not deflect within the plugging structure 40 and maintains at position stable and accurate, thereby ensuring the accurate position of the optical receptacle 20 with high reliability, so it is easy to assemble and repair the optical receptacle 20 rapidly.

Referring to FIG. 3, further, the pressing piece 30 is provided with at least one elastic piece structure 31. The elastic piece structure 31 has an elastic piece 31a that abuts against the optical receptacle 20 along the axial direction of the optical receptacle 20. Both ends of the pressing piece 30 abut against the plugging structure 40, so that the elastic piece 31a presses the optical receptacle 20 into the adapter 12.

In this embodiment, the elastic piece structure 31 provided on the pressing piece 30 elastically pushes the optical receptacle 20, so that the optical receptacle 20 obtains a preload force for supporting it in the adapter 12 along axial direction thereof, thereby limiting the optical receptacle 20 from being deflected in the axial direction, and preventing loosening from occurring between the optical receptacle 20 and the adapter 12, so as to ensure the accuracy of the position between the optical receptacle 20 and the adapter 12. Specifically, by utilizing the elastic deformation of the elastic piece 31a, one side thereof provides a force for the pressing piece 30 to abut against the plugging structure 40, and the opposite side thereof provides a force for the optical receptacle 20 to abut against the adapter 12, thereby preventing the pressing piece 30 from loosening in the housing 10, so that the optical receptacle 20 is fixed to the accurate position inside the adapter 12 through the pressing piece 30.

The optical receptacle 20 is elastically supported in the adapter 12 through the elastic piece structure 31 provided on the pressing piece 30, and since the two opposite ends of the pressing piece 30 are plugged into the plugging structure 40, it is difficult for deflection and loosening to occur when the pressing piece 30 is pressed against the optical receptacle 20, thus ensuring the accurate mounting position of the optical receptacle 20 and avoiding the problem of light loss.

Further, the housing 10 includes a first housing 13 and a second housing 14 that cover each other. In this embodiment, the first housing 13 and the second housing 14 are connected together through fasteners to facilitate the configuration and maintenance of the circuit board and the optical assembly in the housing 10.

Referring to FIG. 4, specifically, the first housing 13 includes a bottom plate 13a, and the plugging structure 40 includes a first resisting wall 41 disposed on both sides of the bottom plate 13a and extending in a direction perpendicular to the bottom plate 13a. Both ends of the pressing piece 30 respectively abut against the first resisting wall 41.

In this embodiment, the plugging structure 40 has a first resisting wall 41 extending in a direction perpendicular to the bottom plate 13a, and both ends of the pressing piece 30 abut against the first resisting wall 41. In this way, the pressing piece 30 may be plugged and unplugged in a direction perpendicular to the bottom plate 13a, that is, realizing plugging and unplugging from the plugging structure 40 along the up and down direction shown in FIG. 1. When it is necessary to assemble or remove the pressing piece 30, it is only required to plug in or unplug out the pressing piece 30 from the top of the first housing 13 in a direction perpendicular to the bottom plate 13a. The process is simple and easy to operate. Moreover, after the first housing 13 and the second housing 14 are combined, the pressing piece 30 is enclosed between the first housing 13 and the second housing 14 and is less susceptible to external interference. The pressing piece 30 is fixed through the above-mentioned plugging method, so that both ends of the pressing piece 20 receive balanced force from bottom to top. The plugging and fixing is simple and convenient with good stability, and it is easy to expand multiple elastic pieces 31a in a vertical direction to meet the requirement of fixing the multi-layer optical receptacles 20.

Further, the adapter 12 has a second resisting wall 12a that abuts against one side of the optical receptacle 20 close to the optical port 11 along the axial direction of the optical receptacle 20, and the elastic piece 31a abuts against one side of the optical receptacle 20 facing away from the optical port 11.

In this embodiment, one side of the optical receptacle 20 close to the optical port 11 abuts against the second resisting wall 12a, and one side away from the optical port elastically abuts against the elastic piece 31a. Therefore, the elastic resistance force of the elastic piece 31a acting on the optical receptacle 20 is directed toward the outside of the optical port 11, that is, the elastic piece 31a provides an elastic preload force to the optical receptacle 20 toward the outside of the optical port 11. When the external connector is plugged into the adapter 12, the force of the external connector is applied along the axial direction of the optical receptacle 20 and toward inside of the optical port 11. This force will be offset by the elastic deformation of the elastic piece 31a, thereby ensuring the accurate position between the optical receptacle 20 and the adapter 12.

Further, the first resisting wall 41 is disposed opposite to the second resisting wall 12a. In this embodiment, the first resisting wall 41 and the second resisting wall 12a are disposed oppositely along the axis of the optical receptacle 20 and are arranged parallel to each other. Therefore, the two resisting walls abutting against both ends of the pressing piece 30 are coplanar with each other to form the first resisting wall 41. When the elastic piece 31a is elastically deformed, the pressing piece 30 is driven to abut against the first resisting wall 41, and the optical receptacle 20 is driven to abut against the second resisting wall 12a, so that after the pressing piece 30 fixes the optical receptacle 20, the optical receptacle 20 and the pressing piece 30 are in a balanced state of force in the housing 10.

Furthermore, the first housing 13 further includes side walls 13b provided on both sides of the bottom plate 13a respectively, and the first resisting wall 41 is disposed on the side walls 13b. As shown in FIG. 4, in this embodiment, the adapter 12 and the first housing 13 are formed integrally, thereby saving the manufacturing cost of the housing 10. Since the adapter 12 is formed integrally with the first housing 13, the first resisting wall 41 may be directly formed on the side walls 13b of the first housing 13 during molding. Of course, the first resisting wall 41 may also be formed on the adapter 12.

Specifically, the adapter 12 further has a position-limiting hole 12c extending along the axial direction of the optical receptacle 20. The optical receptacle 20 includes a sleeve 20a and a flange 20b protruding radially along the optical receptacle 20. The sleeve 20a on one side of the flange 20b toward the adapter 12 is adaptively disposed in the position-limiting hole 12c adapter. One end of the flange 20b abuts against the second resisting wall 12a, and the other end abuts against the elastic piece 31a.

Continuing to refer to FIG. 2, FIG. 3 and FIG. 4, in this embodiment, the sleeve 20a on one side of the optical receptacle 20 close to the adapter 12 is adaptively disposed in the position-limiting hole 12c to ensure that the optical receptacle 20 does not deflect radially in the adapter 12. One side of the flange 20b along the axial direction of the optical receptacle 20 abuts against the second resisting wall 12a, and the opposite side of the flange 20b along the axial direction of the optical receptacle 20 abuts against the elastic piece 31a, thereby ensuring that the flange 20b does not deflect in the axial direction of the optical receptacle 20, and thus ensuring that the optical receptacle 20 does not deflect along the axial direction of the optical receptacle 20.

Specifically, the pressing piece 30 is a sheet structure, and the sheet structure includes a plug-in board 32 and the elastic piece structure 31. Both ends of the plug-in board 32 are plugged into the plugging structure 40. In this embodiment, the plug-in board 32 is adapted to the plugging structure 40. Since the plug-in board 32 adopts a flat plate structure, the plugging structure 40 may be configured as a “C”-shaped groove or “L”-shaped groove to be adapted to the plug-in board 32. When the plug-in board 32 is plugged into the plugging structure 40, the front and rear ends of the right panel of the plug-in board 32 respectively abut against the first resisting wall 41, and the front and rear ends of the plug-in board 32 are limited in the plugging structure 40, thereby limiting the pressing piece 30 from deflecting in the housing 10 in the front-back direction.

Furthermore, the plug-in board 32 is provided with receding channels 33 extending along the insertion direction thereof. In this embodiment, the insertion direction of the plug-in board 32 refers to the direction perpendicular to the bottom plate 13a. When the pressing piece 30 performs a plugging and unplugging operation on the plugging structure 40 in a direction perpendicular to the bottom plate 13a, the receding channels 33 provided on the plug-in board 32 ensures that there is no interference between the plug-in board 32 and the optical receptacles 20.

Specifically, the receding channel 33 is adapted to the sleeve 20a of the optical receptacle 20 located on one side of the flange 20b facing away from the adapter 12. In this embodiment, the setting of the receding channel 33 prevents the sleeve 20a of the optical receptacle 20 located on one side of the flange 20b facing away from the adapter 12 from being deflected with respect to the pressing piece 30 in the front-back direction, thereby limiting the optical receptacle 20 from being deflected in the front-back direction.

Further, the elastic piece structure 31 includes at least two elastic pieces 31a. As shown in FIG. 3, the two elastic pieces (31a, 31b) are respectively disposed on both sides of the receding channel 33. In this embodiment, the sleeve 20a on one side of the flange 20b facing away from the adapter 12 is limited between two elastic pieces 31a adjacent to it, thereby limiting the optical receptacle 20 from being deflected in the front-back direction. Moreover, the two elastic pieces 31a of the elastic piece structure 31 are symmetrically arranged on both sides of the receding channel 33 to improve the stability of the elastic piece structure 31 elastically abutting against the optical receptacle 20.

Specifically, the elastic piece 31a includes a resisting portion 31al that abuts against the flange 20b, and a connection portion 31a2 that connects the resisting portion 31al and the plug-in board 32. The connection portion 31a2 is able to be deformed with respect to the plug-in board 32. In this embodiment, the resisting portion 31al and the plug-in board 32 are parallel to each other, and the distance between the resisting portion 31al and the second resisting wall 12a is smaller than the distance between the plug-in board 32 and the second resisting wall 12a. The connection portion 31a2 is inclined from the end connected to the plug-in board 32 to the end connected to the resisting portion 31a1. When the relative distance between the resisting portion 31al and the plug-in board 32 becomes smaller, the connection portion 31a2 is driven to elastically deform to generate an elastic force. This elastic force drives the resisting portion 31al and the plug-in board 32 to obtain mutually opposite forces, thus providing a preload force along the axial direction to the optical socket 20. Of course, the resisting portion 31al does not have to be flat, and may also be in other shapes. The inclination direction of the connection portion 31a2 may also be set according to the relative positional relationship between the plugging structure and the flange 20b during actual use.

Furthermore, the end of the resisting portion 31al facing away from the connection portion 31a2 is a free end. In this embodiment, the resisting portion 31al has a fixing end connected to the end of the connection portion 31a2 and a free end facing away from the connection portion 31a2. When the pressing piece 30 is mounted along the insertion direction, the free end of the resisting portion 31al may be shifted or inclined relative to the plug-in board 32, so that the elastic piece 31a is pressed against the optical receptacle 20.

Furthermore, the free end is provided with a guide portion 31a3, and the guide portion 31a3 is inclined in a direction facing away from the flange 20b. In this embodiment, the guide part 31a3 is disposed at the upper end of the resisting portion 31al, and the connection portion 31a2 is disposed at the lower end of the resisting portion 31al, so that when the pressing piece 30 is upwardly separated from the plugging structure 40, the upper end of the resisting portion 31al does not interfere with the adjacent optical receptacle 20 or the adapter 12. In this manner, it is easy for the pressing piece 30 to be unplugged, so that the pressing piece 30 may be easily plugged and unplugged. Of course, the relative positions of the guide portion 31a3 and the connection portion 31a2 in the resisting portion 31al may also be set as necessary. For example, the guide portion 31a3 is disposed at the lower end of the resisting portion 31al, and the connection portion 31a2 is disposed at the upper end of the resisting portion 31a1.

Further, the connection portion 31a2, the resisting portion 31al and the free end extend along the insertion direction. The entire elastic piece 31a extends along the vertical direction, thus increasing the area of the elastic piece 31a that abuts against the flange 20b, thereby improving the stability of the elastic piece 31a pressing against the optical receptacle 20.

Furthermore, at least two receding channels 33 are disposed on the plug-in board 32. In this embodiment, the two receding channels 33 are arranged in an array along the front-back direction, so that a single pressing piece 30 may fix at least two optical receptacles 20 in the front-back direction, and is easy to be assembled and disassembled.

Further, at least two elastic piece structures 31 are disposed along the extending direction of each receding channel 33, and the number of the elastic piece structures 31 corresponds to the number of the optical receptacles 20 one-to-one.

In the embodiment, the pressing piece 30 has at least two elastic piece structures 31 in the vertical direction, and the receding channels 33 of the two elastic piece structures 31 arranged in the vertical direction are connected with each other, so that when the pressing piece 30 is plugged and unplugged, there is no interference between the plug-in board 32 and the optical receptacle 20. Moreover, this method enables a single pressing piece 30 to fix at least two optical receptacles 20 in the vertical direction, and facilitates the assembly and disassembly process. The pressing piece 30 adopts a plug-in fixation method in which both ends of it are plugged into plugging structures 40 on both sides, and the receding channel 33 extends along the insertion direction. When the elastic piece 31a abuts against the optical receptacle 20, both ends of the pressing piece 30 receive balanced force from bottom to top. Therefore, when two or more layers of optical receptacles 20 are arranged in the vertical direction, two or more elastic piece structures 31 may be conveniently arranged on the pressing piece 30 correspondingly along the extending direction (vertical direction) of each receding channel 33, and when each elastic piece structure 31 abuts against the corresponding optical receptacle 20, the force is still evenly transmitted to both ends of the pressing piece 30. It is also possible to achieve good stability and meet the requirements of fixing the multi-layer optical receptacles 20.

In this embodiment, the drawing exemplifies that a single pressing piece 30 is able to press or loosen four optical receptacles 20 simultaneously. The four optical receptacles 20 are arranged in the front-back and vertical directions respectively. Such method not only reduces the manufacturing cost, but also makes it convenient to assemble and disassemble multiple optical receptacles 20. The four optical receptacles 20 may be two optical receiving end sockets and two optical transmitting end sockets respectively. Of course, the four optical receptacles 20 may also be four receiving end sockets or four transmitting end sockets, or four bidirectional transceiver optical receptacles.

Further, the pressing piece 30 further includes a handle plate 34 connected to the end of the plug-in board 32. The handle plate 34 extends in a direction facing away from the second resisting wall 12a. The handle plate 34 is disposed on the end of the plug-in board 32 relatively far away from the bottom plate 13a. In this embodiment, the handle plate 34 is disposed at the upper end of the plug-in board 32 to facilitate the user to plug and unplug the entire pressing piece 30 from above and facilitate the user's operation.

Specifically, the pressing piece 30 is made of elastic conductive material, which may simultaneously have an EMI protection effect and improve the EMI protection performance of the optical module. In this embodiment, the pressing piece 30 is subjected to a force to produce elastic deformation, thereby offsetting the force generated between the external connector and the optical receptacle 20. The pressing piece 30 is preferably made of an elastic metal material, and is formed integrally, such as a sheet metal member, thus saving production and manufacturing costs.

Referring to FIG. 5 and FIG. 6, the disclosure further provides an optical module in another embodiment. In this embodiment, the first housing 13 and the adapter 12 are designed in a separate manner, so it is easy to replace and repair the adapter 12 or the first housing 13 individually in future.

Specifically, opposite protrusions 12b are disposed at both ends of the second resisting wall 12a of the adapter 12, and the first resisting wall 41 is disposed on the protrusions 12b. In this embodiment, the first resisting wall 41 is formed on an independent adapter 12, that is, the entire plugging structure 40 is formed on the adapter 12. In this way, the optical receptacle 20 may first be limited and fixed with the adapter 12 through the pressing piece 30, and then the adapter 12 and the first housing 13 may be fixed through fasteners. Such method may facilitate the connection between the optical fiber in the optical receptacle 20 and the circuit board, and also facilitates the subsequent replacement and maintenance of the optical receptacle 20. The assembly of the adapter 12 and the optical receptacle 20 may be carried out simultaneously with the assembly of circuit boards and other components in the housing 10. They are assembled into two sub-assemblies respectively, and then the two sub-assemblies are assembled into an optical module, so it is possible to effectively save the assembly time of a single module and improve production efficiency.

Further, the pressing piece 30 further includes position-limiting protrusions 35 protruding from both ends of the plug-in board 32, and the position-limiting protrusions 35 are symmetrically arranged relative to the handle plate 34. The plugging structure 40 further includes a position-limiting portion 42 adapted to the position-limiting protrusion 35 to limit the position of the plug-in board 32.

In this embodiment, when the pressing piece 30 and the adapter 12 are assembled, through the adaptation and docking of the position-limiting protrusion 35 and the position-limiting portion 42, on the one hand, it is possible to avoid deflection and loosening between the pressing piece 30 and the adapter 12, and, on the other hand, avoid dislocation between the pressing piece 30 and the plugging structure 40 when they are adapted to each other. In this way, it is possible to ensure the accuracy of docking between the pressing piece 30 and the optical receptacle 20.

Moreover, the handle plate 34 and the position-limiting protrusion 35 both extend in the direction facing away from the second resisting wall 12a to prevent interference from being generated between the handle plate 34 and the position-limiting protrusion 35 with the second resisting wall 12a and scratching the adapter 12 when the pressing piece 30 is plugged in or unplugged. In this way, it is possible to ensure that the pressing piece 30 may be plugged and unplugged smoothly.

It should be understood that although the present disclosure is described in terms of implementations, not each implementation only contains an independent technical solution. This description of the present disclosure is only for the sake of clarity. Those skilled in the art should take the specification as a whole and understand each individual solution. The technical solutions in the embodiments can also be appropriately combined to form other embodiments that can be understood by those skilled in the art.

The series of detailed descriptions listed above are only specific descriptions of feasible implementations of the present disclosure. They are not intended to limit the scope to be protected by the present disclosure. Any equivalent implementations or changes that do not deviate from the technical spirit of the present disclosure should all be included in the scope to be protected by the present disclosure.

What is claimed is:

1. An optical module, comprising a housing, and a circuit board and an optical assembly disposed in the housing, wherein the housing has an optical port, an adapter is disposed at the optical port, the optical assembly comprises an optical receptacle disposed in the adapter by limited in a radial direction, and wherein the optical module further comprises a pressing piece and a plugging structure disposed in the housing, wherein the plugging structure is oppositely disposed on both sides of an axis of the optical receptacle, two opposite ends of the pressing piece are plugged into the plugging structure; the pressing piece is provided with at least one elastic piece structure, the elastic piece structure has an elastic piece abutting against the optical receptacle along an axial direction of the optical receptacle, and both ends of the pressing piece abut against the plugging structure, so that the elastic piece presses the optical receptacle into the adapter.

2. The optical module according to claim 1, wherein the housing comprises a first housing and a second housing that cover each other, and the first housing comprises a bottom plate:
the plugging structure comprises a first resisting wall located on both sides of the bottom plate respectively and extending in a direction perpendicular to the bottom plate, the both ends of the pressing piece respectively abut against the first resisting wall.

3. The optical module according to claim 2, wherein the adapter has a second resisting wall that abuts against one side of the optical receptacle close to the optical port along the axial direction of the optical receptacle, and the elastic piece abuts against one side of the optical receptacle facing away from the optical port, the first resisting wall and the second resisting wall are disposed opposite to each other.

4. The optical module according to claim 3, wherein the first housing further comprises side walls disposed on the both sides of the bottom plate respectively, and the first resisting wall is disposed on the side walls;
alternatively, the adapter is provided with opposite protrusions respectively at both ends of the second resisting wall, and the first resisting wall is disposed on the protrusions.

5. The optical module according to claim 3, wherein the adapter further has a position-limiting hole extending along the axial direction of the optical receptacle, the optical receptacle comprises a sleeve and a flange protruding along a radial direction of the optical receptacle, the sleeve on one side of the flange facing the adapter is adapted in the position-limiting hole, one end of the flange abuts against the second resisting wall, and the other end abuts against the elastic piece.

6. The optical module according to claim 5, wherein the pressing piece is a sheet structure, and the sheet structure comprises a plug-in board and the elastic piece structure, both ends of the plug-in board are plugged into the plugging structure; the plug-in board is provided with receding channels extending along an insertion direction thereof, and the receding channel is adapted to the sleeve of the optical receptacle located on one side of the flange facing away from the adapter;
the elastic piece structure comprises at least two of the elastic pieces, and the at least two elastic pieces are respectively disposed on both sides of the receding channel.

7. The optical module according to claim 6, wherein the elastic piece comprises a resisting portion abutting against the flange, a connection portion connecting the resisting portion and the plug-in board, and the connection portion is able to be deformed relative to the plug-in board.

8. The optical module according to claim 7, wherein one end of the resisting portion facing away from the connection portion is a free end.

9. The optical module according to claim 8, wherein the free end is provided with a guide portion, and the guide portion is inclined in a direction facing away from the flange:
the connection portion, the resisting portion and the free end extend along the insertion direction.

10. The optical module according to claim 6, wherein at least two of the receding channels are disposed on the plug-in board, and at least two of the elastic piece structures are disposed along an extending direction of each of the receding channels, the number of the elastic piece structures corresponds to the number of the optical receptacles one-to-one.

11. The optical module according to claim 10, wherein the pressing piece further comprises a handle plate connected to an end of the plug-in board, and the handle plate extends in a direction facing away from the second resisting wall;
the handle plate is disposed at one end of the plug-in board that is relatively far away from the bottom plate.

12. The optical module according to claim 11, wherein the pressing piece further comprises a position-limiting protrusion protruding from the both ends of the plug-in board, and the position-limiting protrusion is symmetrically arranged relative to the handle plate; the plugging structure further comprises a position-limiting portion that is adapted to the position-limiting protrusion to limit a position of the plug-in board.

13. The optical module according to claim 1, wherein the pressing piece is made of elastic conductive materials.
